(19) United States
(12) Patent Application Publication
(10) Pub. No.: US 2022/0090440 A1
(43) Pub. Date: Mar. 24, 2022

(54) Automatic Door Bottom With Intumescent Extended Drop

(71) Applicant: Legacy Manufacturing LLC, Bronx, NY (US)

(72) Inventor: Jacob Wexler, Scarsdale, NY (US)

(21) Appl. No.: 17/029,566

(22) Filed: Sep. 23, 2020

(51) Int. Cl. E06B 5/16; E06B 7/215

(52) U.S. Cl. CPC E06B 5/164; E06B 7/215

(57) ABSTRACT

An automatic door bottom to seal a gap between a door bottom and a door sill and includes a drop bar assembly with a seal element is held in a channel mounted on a door. The automatic door bottom also includes a spring-loaded, slidable pushrod assembly which, upon closure of the door, forces the seal element out of the channel and into contact with the door sill. Upon door opening, the slidable pushrod assembly is released and retracts the seal element back into the channel. Further included within the channel is an intumescent material also communicating with the drop bar assembly, where, when exposed to heat or high temperature, forcefully expands within the channel to force the seal element out of the channel and into sealable contact with the door sill, thereby preventing fire expansion through a gap around the door.

### FIELD OF THE INVENTION

The present invention relates generally to sealing a gap between a door bottom and an underlying sill; and more particularly to an automatic door bottom mechanism automatically actuated to seal a gap between a door bottom and an underlying sill, both when a door is closed or because of excessive heat or fire.

### BACKGROUND OF THE INVENTION

Typically, door bottom seals or weatherstrips comprise a flexible sealing element held within a mounting means attached to the bottom of a door. The purpose of the weatherstrip is to block drafts, light, noise, and foreign objects from passing through the space normally provided between the bottom of the door and the door sill. However, these sealing means are subject to wear and deterioration due to the rubbing of the sealing element against the door sill and floor as the door is opened and closed. This is especially true if the sealing element is forced against the door sill to obtain a more effective seal. Moreover, if the floor near the door sill is covered with carpeting, the sealing element causes undue wear on the carpet and requires unnecessary effort to operate the door. Additionally, in actual installation, the floor and door bottom are not necessarily parallel and therefore a completely effective seal is not possible with a fixed element. Further, a fixed sealing element fails to provide a complete sealing, blocking all air, smoke and fire, during a fire event.

What is needed is an automatic door bottom with intumescent extended drop that can be automatically actuated to completely seal a gap between a door bottom and an underlying sill, both when a door is closed or because of excessive heat or fire.

### SUMMARY OF THE INVENTION

The present invention is an automatic door bottom for sealing a gap between a bottom of a door and its adjacent sill when the door is closed. The automatic door bottom is also configured to automatically seal the gap between a door bottom and its adjacent door sill upon fire or excessive heat.

The door bottom comprises an inverted U-shaped channel which can have an entirely open U-shape, or can be internally divided into upper and lower sections. The door bottom can be mounted along or within a bottom of a door. A flexible sealing element is carried within the channel on a drop bar assembly. In one aspect, a pushrod assembly with a spring mechanism is provided for reciprocating the sealing element partially out of and back into the channel upon closing and opening the door respectively. The pushrod assembly is actuated to reciprocate the sealing element by a plunger extending from the channel, where the plunger, bearing against a jamb of the door as the door is closed, actuates the spring mechanism to extend the sealing element out of the channel when the door is closed, and to retract the sealing element back into the channel when the door is opened. The door bottom and pushrod assembly are configured to push the drop bar assembly out of the channel, and against the adjacent sill, in a scissor-like manner, beginning at one end (the door hinge end) and transitioning to the opposite end.

In another aspect, an intumescent is used to activate the drop bar assembly and seal the gap between the door bottom and adjacent sill. The intumescent activation occurs upon exposure to heat or temperature above a predetermined threshold. Upon reaching and passing the predetermined threshold, the intumescent forcefully expands within the channel, fills all internal areas of the channel, then acts to pushes the drop bar assembly downward, out of the channel, sealing against the sill below.

In one embodiment, an automatic door bottom includes an inverted U-shaped channel with an upper internal section disposed along a closed end of the channel and a lower internal section disposed along an open end of the channel, a drop bar assembly including a flexible sealing element slidably disposed within the inverted U-shaped channel, and an intumescent material communicating with the upper internal section of the inverted U-shaped channel and with an upper portion of the drop bar assembly. The intumescent material is configured, when exposed to heat or temperature above a predetermined threshold, to forcefully expand within the upper internal section of the inverted U-shaped channel to push the drop bar assembly slidably within the channel, where at least the sealing element extends from the open end of the channel and seals the drop bar assembly against a sill beneath a door to which the automatic door bottom is configured to be attached. In this embodiment, the drop bar assembly can include one or more channels extending longitudinally along an upper portion of the drop bar assembly, the one or more channels housing the intumescent.

In another embodiment, an automatic door bottom includes an inverted U-shaped channel having facing longitudinal rib members formed internally thereof dividing the channel into upper and lower internal sections, with the upper internal section disposed along a closed end of the channel and the lower internal section disposed along an open end of the channel. Also included are a drop bar assembly including a flexible sealing element slidably disposed within the lower internal section and an intumescent material communicating at least with an upper portion of the lower internal section of the channel and with an upper portion of the drop bar assembly. The intumescent material is configured, when exposed to heat or temperature above a predetermined threshold, to forcefully expand within at least the upper portion of the lower internal section of the channel and to push the drop bar assembly slidably within the channel, where at least the sealing element extends from the open end of the channel and seals the drop bar assembly against a sill beneath a door to which the automatic door bottom is configured to be attached.

In this embodiment, the automatic door bottom can further include a pushrod assembly including at least one spring mechanism, the pushrod assembly mounted within the upper internal section of the channel and configured to control slidable movement of the drop bar assembly, the pushrod assembly being activated by a plunger extending from the upper internal section of the channel, wherein the plunger is configured to be compressed into the upper internal section of the channel upon door closing against a door frame, the compressing plunger configured to activate the at least one spring mechanism to push the drop bar assembly slidably within the channel, where at least the sealing element extends from the open end of the channel and seals against a sill beneath a door to which the automatic door bottom is attached.

In this embodiment, the spring mechanism can be a flat spring mechanism. Further, the pushrod can be mounted horizontally, and longitudinally within the upper internal section of the channel, and/or the pushrod assembly can be arranged so that the extending plunger operates from a hinge side of the door, the pushrod assembly slidably pushing the drop bar assembly in a scissor-like motion, beginning at a hinge side of the automatic door bottom and scissoring to an opposite end of the automatic door bottom, wherein the scissor-like motion creates a uninterrupted, self-leveling seal along the sill.

The automatic door bottom can further include a sloped top casing configured to slough off rainwater and to prevent pooling on a top of the automatic door bottom. The flexible sealing element can be configured to be concealed within the channel when the door is open.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates an end view of an embodiment of the automatic door bottom of the present invention;

FIG. 2 illustrates a side view of an embodiment of the automatic door bottom of the present invention, the side view shown partially in cross-section to view an internal pushrod assembly of this embodiment;

FIG. 3 illustrates a perspective end view of the automatic door bottom of FIG. 1, FIG. 3 showing a drop bar assembly, an intumescent, and a protruding plunger of this embodiment; and

FIGS. 4a-4c illustrate a scissor-like dropping of the drop bar assembly with sealing element, out of the channel and against the adjacent sill, beginning at one end of the automatic door bottom (the door hinge end) and transitioning to the opposite end, in an embodiment of the present invention.

### DETAILED DESCRIPTION OF THE INVENTION

The contents of U.S. Pat. No. 3,703,788; U.S. Pat. No. 4,947,584; U.S. Pat. No. 5,501,045; U.S. Pat. No. 8,745,924; and U.S. 2004/0010973 are incorporated herein in their entirety by reference.

The present invention is an automatic door bottom for sealing a gap between a bottom of a door and its adjacent sill when the door is closed. The automatic door bottom is also configured to automatically seal the gap between a door bottom and its adjacent door sill upon fire or excessive heat.

The door bottom comprises an inverted U-shaped channel which can have an entirely open U-shape, or can be internally divided into upper and lower sections. The door bottom can be mounted along or within a bottom of a door. A flexible sealing element is carried within the channel on a drop bar assembly. A pushrod assembly with a spring mechanism is provided for reciprocating the sealing element partially out of and back into the channel upon closing and opening the door respectively. The pushrod assembly is actuated to reciprocate the sealing element by a plunger extending from the channel, where the plunger, bearing against a jamb of the door as the door is closed, actuates the spring mechanism to extend the sealing element out of the channel when the door is closed, and to retract the sealing element back into the channel when the door is opened. The door bottom and pushrod assembly are configured to push the drop bar assembly out of the channel, and against the adjacent sill, in a scissor-like manner, beginning at one end (the door hinge end) and transitioning to the opposite end.

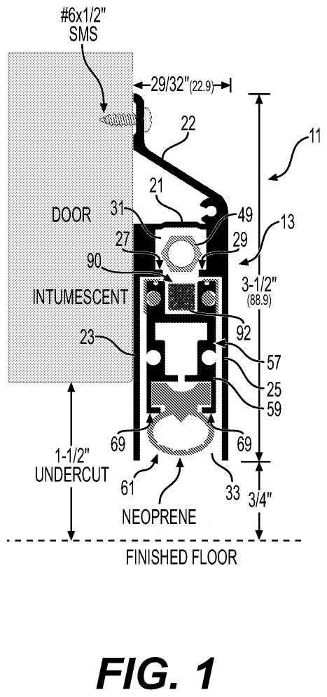

Referring now to the drawings, and initially to FIG. 1, an automatic door bottom 11 of the present invention can include an extruded metallic channel 13, preferably made of aluminum or aluminum alloy. The channel 13 is an inverted “U” shape for mounting along or within the bottom of a door. An upper surface 21 of the channel can include a sloped top casing 22 configured to drain off rainwater and to prevent pooling on a top of the automatic door bottom.

The channel has an elongated, rectangular inverted U-shaped portion comprising a flat horizontal top 21 and two vertical legs 23, 25. An interior surface of the leg portions 23, 25 are provided with integral longitudinal rib members 27, 29 extending toward the opposite leg. These rib members 27, 29 can be approximately one-quarter of the way from the top 21 and divide the interior of the channel 13 into upper and lower internal sections 31, 33 connected by an opening between the ribs 27, 29. The upper section 31 is disposed along the closed portion of the U-shaped channel, adjacent to the flat horizontal top 21, and the lower section 33 is disposed along the open portion of the channel 13. The ribs 27, 29, as shown, are formed during the extruding of the channel 13, but may be made from separate elements and fixed to the legs 23, 25 in any suitable manner.

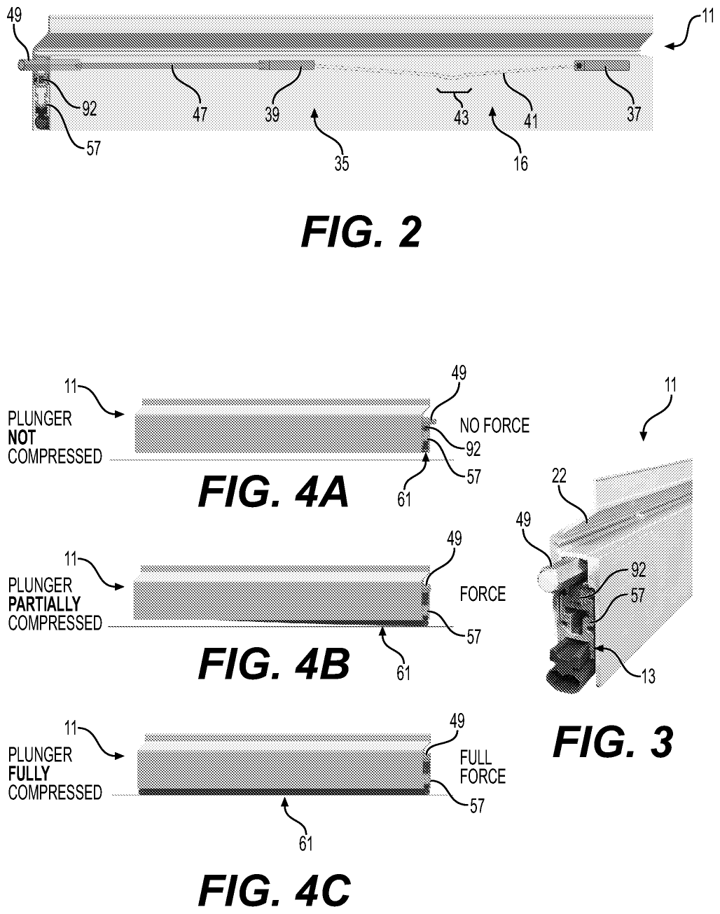

A pushrod assembly 35 with spring mechanism 16, shown in FIG. 2, is slidably insertable into the upper section 31 of the channel 13. The pushrod assembly 35 includes a fixed block 37 and a slide block 39 which are formed to be disposed within the upper internal section 31 of the channel 13. In one embodiment, they are rectangular blocks the first of which, 37, has a drilled and tapped hole formed therein whereby it can be removably secured in the channel 13 in a predetermined position (e.g. by a screw). The second block 39 is freely mounted within the upper internal section and is slidable with respect to the first block 37. The two blocks 37, 39 can be connected by a curved leaf spring 41, preferably of spring steel, which is fixedly attached to the two slide blocks 37, 39 in any convenient manner. The leaf spring 41 can be concave or dish-shaped and has a central portion 43 extending into the lower section 33 of the channel 13.

A pushrod 47 is connected to the slidable second block 39 and projects away from the spring member 41 and out of the end of the channel 13. The pushrod 47 has screw threads formed on the outer end thereof onto which an adjustable end cap (plunger) 49 may be threaded. The plunger (end cap) 49 has a multisided cross-section, preferably hexagonal in shape, and can have a slot formed on its outer end to enable it to be adjusted on the metallic pushrod 47 by a screw driver or the like. The plunger (end cap) 49 makes the pushrod 47 adjustable in length and permits it to be locked against change of adjustment when the door bottom 11 is assembled in operating condition. This is affected by the plunger (end cap) 49 extending into the channel 13 and being of such a size as to be captured within the channel walls and prevented from rotating. In one embodiment, one flat side of the plunger (end cap) 49 rests against the top of the channel 13.

To adjust a length of the pushrod 47, the block 37 is released from its connection with the channel 13, and the pushrod and spring assembly 35 is slid out of the channel 13 until the plunger (end cap) 49 is free thereof and can be turned to effect a new length of the pushrod 47. The pushrod assembly 35 is then reinserted and the first slide block 37 is again secured in position. The plunger (end cap) 49 is then prevented from turning and changing adjustment.

A drop bar assembly 57 is freely mounted within the lower section 33 of the channel 13 and comprises an extruded ribbed member 59 holding a flexible sealing element 61. The drop bar 57 is connected to the pushrod and spring assembly 35 by a pivot pin or the like in an upper compartment formed in the drop bar assembly 57. The bottom compartment of the drop bar includes a pair of horizontally inwardly projecting flanges 69 to hold the sealing element 61 in the drop bar. (See FIG. 1). The sealing element 61 is made, for example, from neoprene and which may include a hollow or sponge filled lower portion.

Further, the drop bar assembly 57 can include a channel 90 in an upper portion thereof, the channel 90 having three sides and being open on an upper side thereof. The channel 90 can extend an entire length of the drop bar assembly 57, or intermittent channel sections can be spaced along the length of the top of the drop bar assembly 57. Tubular or columnar portions of an intumescent 92 (e.g., of square or circular cross-section) are placed in the channel(s) 90. Depending on the configuration of the channel(s) 90, the intumescent 92 may extend an entire length of the drop bar assembly 57, or may intermittently fill the channel 90 sections spaced along the length of the top of the drop bar assembly 57.

To assemble the door bottom 11, the depressed (central) portion 43 of the leaf spring 41 is placed in the upper compartment of the drop bar assembly 57 and is held therein by the pivot pin or any equivalent fastener to form a single or unitary unit. The blocks 37, 39 of the pushrod assembly with spring mechanism 35 are then slid into the upper section 31 of the U-shaped channel 13 while, at the same time the drop bar assembly 57 attached thereto is slid into the lower section 33. The tapped hole in the block 37 is aligned with a hole formed in one of the legs of the channel 13 and a retaining screw is inserted holding the block 39 and thereby the single unit comprising the pushrod 47, spring 41, and drop bar assemblies 57 in position. In the assembled condition, the drop bar assembly 57 rests entirely within the lower section 33 of the U-shaped channel 13. Lastly, the intumescent 92 is placed in the channel 90 longitudinally arranged along the top of the drop bar assembly 57.

The assembled door bottom 11 may be fixed on a door with the bottom of the channel 13 flush with the bottom of the door, or above or below the bottom of the door, where the spacing can be selected to accommodate a gap dimension below the door (as shown in FIG. 1). The pushrod assembly and spring mechanism 35 may be easily inserted from either side of the channel 13, to allow for left hand or right hand installation (for plunger 49 placement on the hinge side of the door). This enables the automatic door bottom 11 to easily accommodate different bottom gaps, and opening from different directions.

The automatic door bottom 11 can be operated to seal the gap between a bottom of a door and its adjacent sill either by use of the pushrod assembly 35, when the door is closed, and/or by use of the intumescent 92, when the automatic door bottom 11 is exposed to heat or temperature above a predetermined threshold.

For operation of the door bottom 11 using the pushrod assembly 35, when the door bottom 11 is mounted on a door, a striker plate (not shown) can be attached to the door jamb in such a position that upon closing the door, the plunger 49 contacts the plate. This causes the plunger 49 to be driven into the channel 13, driving the second slide block 39 in the first internal section 31. The movement of the second slide block 39 causes the leaf spring 41 to be further flexed or dished due to the fixed block 37. As the leaf spring 41 is further dished, it is driven further into the second internal section 33 and pushes against the drop bar assembly 57, thereby forcing the entire drop bar assembly 57 downwardly, against any frictional forces, and partially out of the lower section of the channel 13 until it contacts the door sill. The amount of movement or reciprocation of the drop bar assembly 57, and therefore the pressure of the sealing element 61 against a door sill is, of course, dependent on the space between the bottom of the door and the amount of travel of the sealing element 61. This travel is adjustable by adjusting the end cap 49 on the pushrod 47.

Operation of the door bottom using the intumescent 92 to activate the drop bar assembly 57, and seal the gap between the door bottom and adjacent sill, occurs upon exposure to heat or temperature above a predetermined threshold. Upon reaching and passing the predetermined threshold, the intumescent 92 forcefully expands within the channel(s) 90, and fills all internal open areas around and above the channel(s) 90 and the upper internal walls of the inverted U-shaped channel 13 of the automatic door bottom 11. The forcefully expanding intumescent 92 then pushes the drop bar assembly 57 downward, within the inverted U-shaped channel 13, where at least the sealing element 61 extends from the open end of the channel, and sealing the sealing element 61 against the sill beneath the door to which the automatic door bottom 11 is attached. The amount of movement or reciprocation of the drop bar assembly 57, and therefore the pressure of the sealing element 61 against a door sill is, of course, dependent on the space between the bottom of the door and the amount of travel of the sealing element 61. The intumescent 92, however, is capable of creating a seal satisfying fire code requirements when the sealing element 61 moves to meet the sill, including in a self-leveling arrangement between the door bottom and the adjacent sill.

In many situations of fire or high heat, where the door is already shut, and therefore the sealing element 61 is already sealed against a sill below, the fire or high heat will cause the sealing element 61 to melt or burn away, and/or may cause the pushrod assembly with spring mechanism 35 to malfunction, or fail to maintain downward pressure on the drop bar assembly 57, thereby resulting in gaps under the door, or at least a failing of air sealing under the door. In these situations, activation of the intumescent 92 at the predetermined temperature will act, as described above, to further push the drop bar assembly 57 downward, within the inverted U-shaped channel 13, so that a bottom of the drop bar assembly, with sealing element 61 removed (e.g., at a location of the pair of horizontally inwardly projecting flanges 69) extends from the open end of the channel, and seals (and maintains seal) against the sill beneath the door to which the automatic door bottom 11 is attached. In this situation, maintaining fire code requirements for the door. In certain embodiments of the invention, the intumescent 92 is configured to activate at a temperature coinciding with a temperature the sealing element 61 is likely to fail, or at least begin failure, and the intumescent is configured to expand for a sufficient period of time (e.g., 30-45 minutes) so that a slow, prolonged failure of the sealing element over time will still be fully compensated for by a continual expansion of the intumescent and downward force on the drop bar assembly 57, ensuring necessary and ever-compensating overall gap sealing.

With the door bottom 11 of the present invention installed on the door, the sealing element 61 will be automatically retracted, as the door is opened, entirely into the channel 13 by the action of the spring assembly 41 unflexing as the pressure against the end cap 49 is removed. The door may therefore be opened more easily, without causing undue wear of the sealing element 61. Moreover, upon closure of the door, the sealing element 61 is forced into contact with the door sill only after the door is completely closed. Therefore, the door bottom may be adjusted to ensure maximum travel of the sealing element 61 and thereby more effectively blocking the space between the door and the door sill. In addition, should the door or door sill become misaligned, the adjustability feature of the door bottom 11 allows the travel of the flexible element 61 to be regulated to conform to the space to be blocked.

In order to make the automatic door bottom 11 seal more evenly, and to avoid premature contact of the seal element 61 with the adjacent floor or sill as the door closes, the drop bar assembly with spring mechanism 35 is configured to cause one end of the flexible sealing element 61 to drop down into contact with the door sill before the other end thereof (see FIGS. 4a-4c). In this configuration, an end of the sealing element 61 closest to the plunger 49 is forced out of the channel 13 first, an opposite end of the sealing element 61 is retained (i.e., the end located nearest the block 37) in the channel 13 until after the rest of the sealing element 61 has been forced out of the channel 13. In this manner, as the door is closed the portion of the sealing element 61 nearest the hinge side of the door frame drops down first onto the sill. The portion furthest from the inside of the door and which has not yet moved over the sill remains retracted so as not to rub on the adjacent floor or carpeting. It drops down as the door approaches its fully closed position, when that end of the sealing element has moved over the sill. Conversely, when the door is opened this outer end of element 61 retracts first. Additionally, the present invention has one other unique and important feature: the door bottom is self-leveling due to the unique spring arrangement and its connection with the drop bar assembly 57. A pivot pin simply interconnects the drop bar assembly 57 with the spring 41, and as the pushrod 47 forces the spring 41 to flex, it flattens out against the sealing element 61 in the drop bar assembly 57 and the sealing element 61 conforms to the sill below.

While the invention has been described with reference to an illustrative embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof.

What is claimed is:

1. An automatic door bottom comprising:
an inverted U-shaped channel having facing longitudinal rib members formed internally thereof dividing the channel into upper and lower internal sections, with the upper internal section disposed along a closed end of the channel and the lower internal section disposed along an open end of the channel;
a drop bar assembly including a flexible sealing element slidably disposed within the lower internal section; and
an intumescent material communicating at least with an upper portion of the lower internal section of the channel and with an upper portion of the drop bar assembly;
wherein the intumescent material is configured, when exposed to heat or temperature above a predetermined threshold, to forcefully expand within at least the upper portion of the lower internal section of the channel and to push the drop bar assembly slidably within the channel, where at least the sealing element extends from the open end of the channel and seals the drop bar assembly against a sill beneath a door to which the automatic door bottom is configured to be attached.

2. The automatic door bottom of claim 1, further comprising a sloped top casing configured to slough off rain water and to prevent pooling on a top of the automatic door bottom.

3. The automatic door bottom of claim 1, wherein the flexible sealing element is configured to be concealed within the channel when the door is open.

4. The automatic door bottom of claim 1, further comprising a pushrod assembly including at least one spring mechanism, the pushrod assembly mounted within the upper internal section of the channel and configured to control slidable movement of the drop bar assembly, the pushrod assembly being activated by a plunger extending from the upper internal section of the channel, wherein the plunger is configured to be compressed into the upper internal section of the channel upon door closing against a door frame, the compressing plunger configured to activate the at least one spring mechanism to push the drop bar assembly slidably within the channel, where at least the sealing element extends from the open end of the channel and seals against a sill beneath a door to which the automatic door bottom is attached.

5. The automatic door bottom of claim 4, wherein the spring mechanism is a flat spring mechanism.

6. The automatic door bottom of claim 4, wherein the pushrod is mounted horizontally, and longitudinally within the upper internal section of the channel

7. The automatic door bottom of claim 4, wherein the pushrod assembly is arranged so that the extending plunger operates from a hinge side of the door, the pushrod assembly slidably pushing the drop bar assembly in a scissor-like motion, beginning at a hinge side of the automatic door bottom and scissoring to an opposite end of the automatic door bottom, wherein the scissor-like motion creates a uninterrupted, self-leveling seal along the sill.

8. An automatic door bottom comprising:
an inverted U-shaped channel with an upper internal section disposed along a closed end of the channel and a lower internal section disposed along an open end of the channel;
a drop bar assembly including a flexible sealing element slidably disposed within the inverted U-shaped channel; and
an intumescent material communicating with the upper internal section of the inverted U-shaped channel and with an upper portion of the drop bar assembly;
wherein the intumescent material is configured, when exposed to heat or temperature above a predetermined threshold, to forcefully expand within the upper internal section of the inverted U-shaped channel to push the drop bar assembly slidably within the channel, where at least the sealing element extends from the open end of the channel and seals the drop bar assembly against a sill beneath a door to which the automatic door bottom is configured to be attached.

9. The automatic door bottom of claim 8, wherein the drop bar assembly includes one or more channels extending longitudinally along an upper portion of the drop bar assembly, the one or more channels housing the intumescent.

10. An automatic door bottom comprising:
an inverted U-shaped channel having facing longitudinal rib members formed internally thereof dividing the channel into upper and lower internal sections, with the upper internal section disposed along a closed end of the channel and the lower internal section disposed along an open end of the channel;
a drop bar assembly including a flexible sealing element slidably disposed within the lower internal section;
a pushrod assembly including at least one spring mechanism, the pushrod assembly mounted within the upper internal section of the channel and configured to control slidable movement of the drop bar assembly, and
an intumescent material communicating at least with an upper portion of the lower internal section of the channel and with an upper portion of the drop bar assembly;
wherein the pushrod assembly is activated by a plunger extending from the upper internal section of the channel, wherein the plunger is configured to be compressed into the upper internal section of the channel upon door closing against a door frame, the compressing plunger configured to activate the at least one spring mechanism to push the drop bar assembly slidably within the channel, where at least the sealing element extends from the open end of the channel and seals against a sill beneath a door to which the automatic door bottom is attached; and
wherein the intumescent material is configured, when exposed to heat or temperature above a predetermined threshold, to forcefully expand within at least the upper portion of the lower internal section of the channel and to push the drop bar assembly slidably within the channel, where at least the sealing element extends from the open end of the channel and seals the drop bar assembly against a sill beneath a door to which the automatic door bottom is configured to be attached.

11. The automatic door bottom of claim 10, wherein the spring mechanism is a flat spring mechanism.

12. The automatic door bottom of claim 10, wherein the pushrod is mounted horizontally, and longitudinally within the upper internal section of the channel

13. The automatic door bottom of claim 10, wherein the pushrod assembly is arranged so that the extending plunger operates from a hinge side of the door, the pushrod assembly slidably pushing the drop bar assembly in a scissor-like motion, beginning at a hinge side of the automatic door bottom and scissoring to an opposite end of the automatic door bottom, wherein the scissor-like motion creates a uninterrupted, self-leveling seal along the sill.

14. The automatic door bottom of claim 10, further comprising a sloped top casing configured to slough off rain water and to prevent pooling on a top of the automatic door bottom.

15. The automatic door bottom of claim 10, wherein the flexible sealing element is configured to be concealed within the channel when the door is open.
